(19) United States
(12) Patent Application Publication
(10) Pub. No.: US 2014/0313785 A1
(43) Pub. Date: Oct. 23, 2014

(54) COMPOSITE ELECTRONIC COMPONENT, BOARD HAVING THE SAME MOUNTED THEREON AND POWER STABILIZING UNIT INCLUDING THE SAME

(71) Applicant: SAMSUNG ELECTRO-MECHANICS CO., LTD., Suwon-Si (KR)

(72) Inventor: Jae Hoon LEE, Suwon-Si (KR)

(73) Assignee: SAMSUNG ELECTRO-MECHANICS CO., LTD., Suwon-Si (KR)

(21) Appl. No.: 14/247,943

(22) Filed: Apr. 8, 2014

(30) Foreign Application Priority Data
Apr. 19, 2013 (KR) 10-2013-0043761
Dec. 30, 2013 (KR) 10-2013-0167479

(51) Int. Cl. H02M 3/335; H02M 1/14

(52) U.S. Cl. CPC H02M 3/33507; H02M 1/14
USPC 363/21.01

(57) ABSTRACT

A composite electronic component includes a first power stablizing unit and a second power stabilizing unit. The first power stabilizing unit includes a first input terminal receiving first power supplied from a battery, stabilizing the first power, and supplying the stabilized first power to a power managing unit. The second power stabilizing unit includes a second input terminal receiving second power converted by the power managing unit and an output terminal stabilizing the second power and supplying the stabilized second power as driving power. The first and second power stabilizing units include a capacitor and an inductor to stabilize the powers. The inductor is configured to suppress an alternating current (AC) component of the received power. The capacitor is configured to decrease ripple of the received power.

### CROSS-REFERENCE TO RELATED APPLICATIONS

This application claims priority to, and benefit of, Korean Patent Application Nos. 10-2013-0043761 filed on Apr. 19, 2013 and No. 10-2013-0167479 filed on Dec. 30, 2013, with the Korean Intellectual Property Office, the entire contents of which are hereby incorporated by reference.

### TECHNICAL FIELD

The present disclosure relates to a composite electronic component including passive devices.

### BACKGROUND

Recently, electronic devices need to have a significantly small size and various functions so as to meet demands for slimness, lightness, and high performance.

The electronic devices provide power management integrated circuits (PMICs) for effective control and management of limited battery resources in order to satisfy various service requirements.

However, as various functions are provided in the electronic devices, the number of direct-current (DC)-direct-current (DC) converters provided in the PMICs has increased. Accordingly, the number of passive devices provided in power input terminals and power output terminals of the PMICs has also increased.

In this case, an increase in component mounting areas of the electronic devices causes limitations on the miniaturization of the electronic devices.

In addition, noise may be increased by wiring patterns of the PMICs and peripheral circuits.

### RELATED ART DOCUMENT

Korean Patent Laid-Open Publication No. KR 2003-0014586

### SUMMARY

An aspect of the present disclosure relates to a composite electronic component cable of reducing a component mounting area in a driving power supply system.

An aspect of the present disclosure relates to a composite electronic component capable of suppressing the occurrence of noise in the driving power supply system.

One aspect of the present disclosure encompasses a composite electronic component including a first power stabilizing unit and a second power stabilizing unit. The first power stabilizing unit includes a first input terminal receiving first power supplied from a battery, stabilizing the first power, and supplying the stabilized first power to a power managing unit. The second power stabilizing unit includes a second input terminal receiving second power converted by the power managing unit and an output terminal stabilizing the second power and supplying the stabilized second power as driving power. The first and second power stabilizing units include a capacitor and an inductor to stabilize the powers, the capacitor having a ceramic body in which a plurality of dielectric layers and internal electrodes are stacked, the internal electrodes being disposed to face each other, and a dielectric layer being interposed therebetween. The inductor has a magnetic main body including coil units and magnetic bodies. The inductor is configured to suppress an alternating current (AC) component of the received power and the capacitor is configured to decrease ripple of the received power.

A ratio of output power to input power (output power/input power) inputted to the second power stabilizing unit may be 85% or more.

A frequency of the power inputted to the second power stabilizing unit or outputted therefrom may be 1 to 30 MHz.

The capacitor may have a capacitance of 1 to 100 μF.

The inductor may have an inductance of 0.01 μH to 1.1 μH.

A volume ratio of the magnetic body to the total volume of the composite electronic component (volume of the magnetic body/volume of the composite electronic component) may be 55% to 95%.

The first and second input terminals may be disposed on a portion of one end surface of the composite electronic component.

A current of the power inputted to the second power stabilizing unit or outputted therefrom may be 1.0 to 10.0 A.

The composite electronic component may further include a ground terminal unit connecting the first power stabilizing unit and the second power stabilizing unit to a ground.

Another aspect of the present disclosure relates to a composite electronic component including a hexahedral composite body including a capacitor coupled to an inductor, first and second input terminals, an output terminal and a ground terminal. The capacitor has a ceramic body in which a plurality of dielectric layers and internal electrodes are stacked. The internal electrodes are disposed to face each other, and a dielectric layer is interposed therebetween. The inductor has a magnetic main body including coil units. The first input terminal is disposed on a first end surface of the composite body and connected to conductive patterns of the inductor. The second input terminal is disposed on the first end surface and spaced apart from the first input terminal and connected to the internal electrodes of the capacitor. The output terminal is disposed on a second end surface of the composite body and connected to the conductive patterns of the inductor and the internal electrodes of the capacitor. The ground terminal is disposed on at least any one of an upper surface, a lower surface, a first side surface, and a second side surface of the composite body and connected to the internal electrode of the capacitor. The inductor and the capacitor are connected in series.

The magnetic main body may include a plurality of stacked magnetic layers having conductive patterns disposed thereon and the conductive patterns may configure the coil units.

The inductor may have a thin film form in which the magnetic main body includes an insulating substrate and coils disposed on at least one surface of the insulating substrate.

The magnetic main body may include a core and a wiring coil wound on the core.

A ratio of output power to input power (output power/input power) inputted to the composite body may be 85% or more.

A frequency of the power inputted to the composite body or outputted therefrom may be 1 to 30 MHz.

The capacitor may have a capacitance of 1 to 100 μF.

The inductor may have an inductance of 0.01 μH to 1.1 μH.

A volume ratio of the magnetic body to the total volume of the composite body (volume of the magnetic body/volume of the composite body) may be 55% to 95%.

The first and second input terminals may be disposed on a portion of one end surface of the composite electronic component.

A current of the power inputted to the composite body or outputted therefrom may be 0.1 to 10.0 A.

The internal electrode may include a first internal electrode having a lead exposed to the first end surface of the composite body, a second internal electrode having leads exposed to one or more of the first and second side surfaces of the composite body, and a third internal electrode having a lead exposed to the second end surface of the composite body.

The inductor may be disposed on an upper portion of the capacitor.

The ceramic body may include first and second capacitor units connected to each other in series.

The capacitor may be disposed on an upper portion and a lower portion of the inductor.

The capacitor may be disposed on both side surfaces of the inductor.

Still another aspect of the present disclosure relates to a composite electronic component used in a power terminal of a portable mobile device, suppressing an alternating current (AC) component of received power, and decreasing ripple. The composite electronic component includes a power stabilizing unit, an input terminal and an output terminal. The power stabilizing unit includes a capacitor coupled to an inductor. The capacitor has a ceramic body in which a plurality of dielectric layers and internal electrodes are stacked, the internal electrodes are disposed to face each other, and a dielectric layer are interposed therebetween. The inductor has a magnetic main body including coil units and magnetic bodies. The input terminal is disposed on one end surface of the power stabilizing unit and receiving power converted by a power managing unit. The output terminal is disposed on one end surface of the power stabilizing unit and supplies the power stabilized by the power stabilizing unit. The inductor is configured to suppress the AC component of the received power and the capacitor is configured to decrease ripple of the received power.

Another aspect of the present disclosure relates to a board having a composite electronic component mounted thereon. The board includes a printed circuit board having electrode pads disposed thereon, the composite electronic component as described above disposed on the printed circuit board and a solder connecting the electrode pad to the composite electronic component.

Another aspect of the present disclosure relates to a power stabilizing unit including a composite electronic component, a battery, a first power stabilizing unit stabilizing power supplied from the battery, a power managing unit converting the power received from the first power stabilizing unit by a switching operation, and a second power stabilizing unit stabilizing power received from the power managing unit. The second power stabilizing unit is the composite electronic component including a capacitor and an inductor. The capacitor has a ceramic body in which a plurality of dielectric layers and internal electrodes are stacked. The internal electrodes are disposed to face each other, and a dielectric layer is interposed therebetween. The inductor has a magnetic main body including coil units and magnetic bodies. The inductor is configured to suppress an alternating current (AC) component of the received power and the capacitor is configured to decrease ripple of the received power.

The power managing unit may include a transformer insulating a first side from a second side, a switching unit positioned on the first side of the transformer and configured to switch the power received from the power managing unit. A pulse width modulation integrated circuit (PWM IC) is configured to control the switching operation of the switching unit, and a rectifying unit is positioned on the second side of the transformer and configured to rectify the converted power.

Still another aspect of the present disclosure relates to a composite electronic component including a hexahedral composite body including a capacitor coupled to an inductor, first and second input terminals, an output terminal and a ground terminal. The capacitor has a ceramic body in which a plurality of dielectric layers and internal electrodes are stacked, the internal electrodes are disposed to face each other, and a dielectric layer being interposed therebetween. The inductor has a magnetic main body including coil units. The first input terminal is disposed on a first end surface of the composite body and connected to conductive patterns of the inductor. The second input terminal is disposed on the first end surface and spaced apart from the first input terminal and connected to the internal electrodes of the capacitor. The output terminal is disposed on a second end surface of the composite body and connected to the conductive patterns of the inductor and the internal electrodes of the capacitor. The ground terminal is disposed on at least any one of an upper surface, a lower surface, a first side surface, and a second side surface of the composite body and connected to the internal electrode of the capacitor. The inductor and the capacitor are connected in series. Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF DRAWINGS

The above and other aspects, features and other advantages of the present disclosure will be more clearly understood from the following detailed description taken in conjunction with the accompanying drawings, in which like reference characters may refer to the same or similar parts throughout the different views. The drawings are not necessarily to scale, emphasis instead being placed upon illustrating the principles of the embodiments of the present inventive concept. In the drawings, the thickness of layers and regions may be exaggerated for clarity.

FIG. 1 is a view illustrating a driving power supply system supplying driving power from a battery and a power managing unit to a predetermined terminal requiring driving power.

FIG. 2A is a view illustrating a waveform of a power supply voltage outputted from the power managing unit.

FIG. 2B is a view illustrating a current waveform after power outputted from the power managing unit passes through a power inductor.

FIG. 2C is a view illustrating a voltage waveform after power having passed through the power inductor passes through a second capacitor.

FIG. 3 is a view illustrating an exemplary configuration in which the driving power supply system is implemented.

FIG. 4 is a circuit diagram of a composite electronic component according to an embodiment of the present disclosure.

FIG. 5 is a detailed circuit diagram of a power stabilizing unit including a composite electronic component according to an embodiment of the present disclosure.

FIG. 6 is a view illustrating an exemplary configuration in which a driving power supply system having a composite electronic component applied thereto according to an embodiment of the present disclosure is disposed.

FIG. 7 is a perspective view schematically illustrating a composite electronic component according to an embodiment of the present disclosure.

FIG. 8 is a cross-sectional view taken along A-A′ in the composition electronic component shown in FIG. 7 according to a first exemplary embodiment of the present disclosure.

FIG. 9 is a cross-sectional view taken along A-A′ in the composition electronic component shown in FIG. 7 according to a second exemplary embodiment of the present disclosure.

FIG. 10 is a cross-sectional view taken along A-A′ in the composition electronic component shown in FIG. 7 according to a third exemplary embodiment of the present disclosure.

FIG. 11 is an exploded perspective view of the composite electronic components of FIG. 7 stacked on one another according to the first exemplary embodiment of the present disclosure.

FIG. 12 is a plan view of an internal electrode disposed in a multilayer ceramic capacitor among the composite electronic components shown in FIG. 7.

FIG. 13 is an equivalent circuit diagram of the composite electronic component shown in FIG. 7.

FIG. 14 is a perspective view schematically illustrating a composite electronic component according to another embodiment of the present disclosure.

FIG. 15 is a perspective view schematically showing a composite electronic component according to still another embodiment of the present disclosure.

FIG. 16 is a perspective view showing a state in which the composite electronic component shown in FIG. 7 is mounted on a printed circuit board.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

A composite electronic component according to an embodiment of the present disclosure may include a first power stabilizing unit and a second power stabilizing unit. The first power stabilizing unit may include a first input terminal receiving a first power supplied from a battery, stabilizing the first power, and supplying the stabilized first power to a power managing unit. The second power stabilizing unit may include a second input terminal receiving a second power converted by the power managing unit and an output terminal stabilizing the second power and supplying the stabilized second power as a driving power. The first and second power stabilizing units may include a capacitor and an inductor to stabilize the powers. The capacitor may have a ceramic body in which a plurality of dielectric layers and internal electrodes are stacked. The internal electrodes may be disposed to face each other, and a dielectric layer may be interposed therebetween. The inductor may have a magnetic main body including coil units and magnetic bodies. The inductor may suppress an alternating current (AC) component of a received power and the capacitor may decrease ripple of the received power.

The composite electronic component according to an embodiment of the present disclosure may be a composite electronic component including a partial inductor and two capacitors among a plurality of inductors and capacitors connected to power managing unit (PMIC) to stabilize power, as a single component.

According to an embodiment of the present disclosure, a capacitor of the first power stabilizing unit may receive a first power supplied from a battery, stabilize the first power, and supply the stabilized first power to a power managing unit (PMIC). An inductor and a capacitor of the second power stabilizing unit receiving power converted by the PMIC and stabilizing the converted power may be implemented as a single composite component. However, the present disclosure is not limited thereto. Various components connected to the power managing unit may be implemented as a single composite component.

Therefore, the composite electronic component may be a composite component including a single inductor and two capacitors connected to the power managing unit (PMIC) as a single component, but may be operable as an array type composite component including a plurality of inductors and capacitors as a single component.

The composite electronic component may include the first power stabilizing unit including the first input terminal receiving the first power supplied from the battery, stabilizing the first power, and supplying the stabilized first power to the power managing unit, and the second power stabilizing unit including the second input terminal receiving the second power converted by the power managing unit and the output terminal stabilizing the second power and supplying the stabilized second power as a driving power. The first and second power stabilizing units may include a capacitor and an inductor. The capacitor may have a ceramic body in which a plurality of dielectric layers and internal electrodes are stacked. The internal electrodes may be disposed to face each other, and a dielectric layer may be interposed therebetween. The inductor may have a magnetic main body including coil units and magnetic bodies.

As described above, the composite electronic component, which is a power component to be connected in the power managing unit (PMIC), may be different from a general composite component including an inductor and a capacitor for high frequency filter in view of various aspects such as design, a manufacturing process, and the like, due to a difference in materials, capacitance, and the like, as described below.

Hereinafter, description of a composite electronic component according to an embodiment of the present disclosure will be described in detail.

A ratio of an output power to an input power (output power/input power) inputted to the second power stabilizing unit may be 85% or more.

The second power stabilizing unit may serve to receive power having a voltage converted by the power managing unit and stabilize the power as described above. Here, in order to supply power with a limited capacitance of battery in a mobile device for a longer period, a ratio of the output power to the input power, for example, power efficiency, may be 85% or more.

For example, in the composite electronic component according to an embodiment of the present disclosure, the inductor may be a power inductor having an inductance of 0.01 μH to 1.1 μH and the capacitor may be a high capacitance component having a capacitance of 1 to 100 μF, such that the power efficiency which is inputted or outputted may be 85% or more, unlike the general composite component including an inductor and a capacitor for high frequency filter, as described below.

A frequency of the power inputted to the second power stabilizing unit or outputted therefrom may be 1 to 30 MHz.

As a switching frequency of the power inputted to the second power stabilizing unit or outputted therefrom becomes low, an inductor for a high current and having a high inductance may be required, and as the switching frequency becomes high, an inductor for a high current and having a relatively low inductance may be required.

In the case of the inductor for a high current used in a high frequency band and having a relatively low inductance, it is advantageous for an inductor product to be miniaturized. However, power efficiency thereof is deteriorated due to a power loss by switching resistance.

Therefore, according to an embodiment of the present disclosure, a switching frequency having a low frequency band of 1 to 30 MHz may be used.

The general composite component including an inductor and a capacitor for high frequency filter, which is a component used for a signal line, may be used in a high frequency band of 100 MHz or 1 GHz or more. However, the composite electronic component according to an embodiment of the present disclosure, which is a component used for a power line, may be used in a low frequency band of 1 to 30 MHz.

The capacitor may have a capacitance of 1 to 100 μF, but is not necessarily limited thereto.

For example, the capacitor including the composite electronic component according to an embodiment of the present disclosure may be a high capacitance product having a capacitance of 1 to 100 μF in order to remove ripple of the received power.

The inductor may have an inductance of 0.01 to 1.1 μH, but is not necessarily limited thereto.

It is important for a portable mobile device to have a small size and a light weight and a battery with a long usable time.

In view of a technical aspect for having a small size among the above-description, in order to miniaturize the inductor, it is important to decrease switching loss resistance in a DC-DC converter.

When the switching loss resistance is decreased in the DC-DC, efficiency is improved, such that clock speed may be increased, and due to the increased clock speed, an inductance of the inductor may be decreased. When the inductance is decreased, since the number of winding coils in the inductor is decreased, the inductor is capable of being miniaturized.

For example, since the inductor included in the composite electronic component according to an embodiment of the present disclosure serves to receive power converted by the power managing unit to suppress a low frequency alternating current (AC) component included in the power, the inductor may have a high inductance of 0.01 μH to 1.1 μH, for example, the inductor may be a power inductor.

According to an embodiment of the present disclosure, the inductor, which is a miniaturized product having a high inductance of 0.01 μH to 1.1 μH, may have high efficiency in a low frequency band having a switching frequency of 1 to 30 MHz and may be coupled to the capacitor, thereby implementing a composite electronic component.

In the composite electronic component, when the inductance of the inductor is less than 0.01 μH, ripple of the power is increased, thereby causing a problem.

Meanwhile, when a miniaturized inductor used in a portable mobile device has an inductance more than 1.1 μH, and the number of winding coils is increased in order to implement the inductance, a direct-current resistance (Rdc) may be relatively increased and DC-bias characteristic may be deteriorated, thereby deteriorating efficiency.

Therefore, the inductor of the composite electronic component according to an embodiment of the present disclosure may have an inductance of 0.01 μH to 1.1 μH.

Meanwhile, the inductor included in the composite electronic component according to an embodiment of the present disclosure may have a magnetic main body including coil units and magnetic bodies.

In the case of the general composite component including an inductor and a capacitor for high frequency filter, the inductor may include dielectric layers and conductive patterns formed on the dielectric layers, and may implement high impedance. However, the inductor of the composite electronic component according to an embodiment of the present disclosure may implement a high inductance to thereby include a magnetic main body including coil parts and magnetic bodies.

As described above, the inductor according to an embodiment of the present disclosure may include a magnetic main body including coil parts and magnetic bodies, thereby obtaining a high inductance.

A volume ratio of the magnetic body to the total volume of the composite electronic component (volume of the magnetic body/volume of the composite electronic component) may be 55% to 95%.

The volume ratio of the magnetic body to the total volume of the composite electronic component (volume of the magnetic body/volume of the composite electronic component) may be controlled to satisfy the range of 55% to 95%, such that effects such as high DC-bias characteristic, low direct-current resistance (Rdc), and ripple decrease may be obtained.

Meanwhile, when the volume ratio of the magnetic body to the total volume of the composite electronic component (volume of the magnetic body/volume of the composite electronic component) is less than 55%, there may be a problem in implementing an inductor for a high current and having a high inductance, high DC Bias characteristic and low Rdc characteristic required for an inductor used in a low frequency band having a switching frequency of 1 to 30 MHz.

In addition, when the volume ratio of the magnetic body to the total volume of the composite electronic component (volume of the magnetic body/volume of the composite electronic component) is more than 95%, there may be a problem such as ripple decrease due to deterioration of capacitance and performance.

The first and second input terminals may be formed on a portion of one end surface of the composite electronic component.

According to an embodiment of the present disclosure, the first and second input terminals may be formed on a portion of one end surface of the composite electronic component, thereby preventing a self resonant frequency (SRF) of the inductor from being deteriorated.

In the composite electronic component including the inductor coupled to the capacitor according to an embodiment of the present disclosure, when the first and second input terminals are formed on one end surface of the composite electronic component, a parasitic capacitance may occur between the first and second input terminals and the coil units of the inductor, or between the internal electrodes of the capacitor or between the coil units of the inductor and the internal electrodes of the capacitor.

Due to the parasitic capacitance, it is problematic when the self resonant frequency (SRF) of the inductor moves to a low frequency band.

When the self resonant frequency (SRF) moves to a low frequency band as described above, a problem that a frequency region of the inductor usable in an embodiment of the present disclosure is decreased may occur.

For example, since functions of the inductor are not exhibited in a high frequency region having a self resonant frequency (SRF) or more, when the SRF moves to a low frequency band, a problem that the frequency region has a limitation to be used may occur.

However, according to an embodiment of the present disclosure, the first and second input terminals may be formed on a portion of one end surface of the composite electronic component. Therefore, an area occupied by the first and second input terminals may be decreased, such that the parasitic capacitance occurring between the coil units of the inductor and the internal electrodes of the capacitor may be significantly decreased, thereby preventing the SRF from being changed.

A current of the power inputted to the second power stabilizing unit or outputted therefrom may be 0.1 to 10.0 A.

The composite electronic component according to an embodiment of the present application may be used for a low frequency, unlike the general composite component including inductors and capacitors for a high frequency, in which the current of the power inputted to the second power stabilizing unit or outputted therefrom may be 0.1 to 10.0 A, but the present disclosure is not limited thereto.

Meanwhile, the composite electronic component according to an embodiment of the present disclosure may include the inductor coupled to the capacitor, in which a coupling surface obtained by coupling the inductor to the capacitor may have an area matching degree of 95% or more.

When it is assumed that a case in which the coupling surfaces of each component have the same area as each other is 100, the area matching degree of the coupling surface obtained by coupling the inductor to the capacitor may indicate a degree of the same area.

When the area matching degree of the coupling surface obtained by coupling the inductor to the capacitor is 95% or more, defective rate may be significantly decreased at the time of mounting the composite electronic component on a substrate.

More specifically, mounting the composite electronic component on a substrate may be performed by vacuum equipment so that the area matching degree of the coupling surface obtained by coupling the inductor to the capacitor is 95% or more, and defective rate may be significantly decreased at the time of mounting the composite electronic component on a substrate.

When the area matching degree of the coupling surface obtained by coupling the inductor to the capacitor is less than 95%, vacuum may not be uniformly applied to the entire component at the time of mounting the composite electronic component on a board, and a problem that the composite electronic component is defective in being mounted on a board or falls down at the time of being mounted may occur.

Hereinafter, embodiments of the present disclosure will be described in detail with reference to the accompanying drawings.

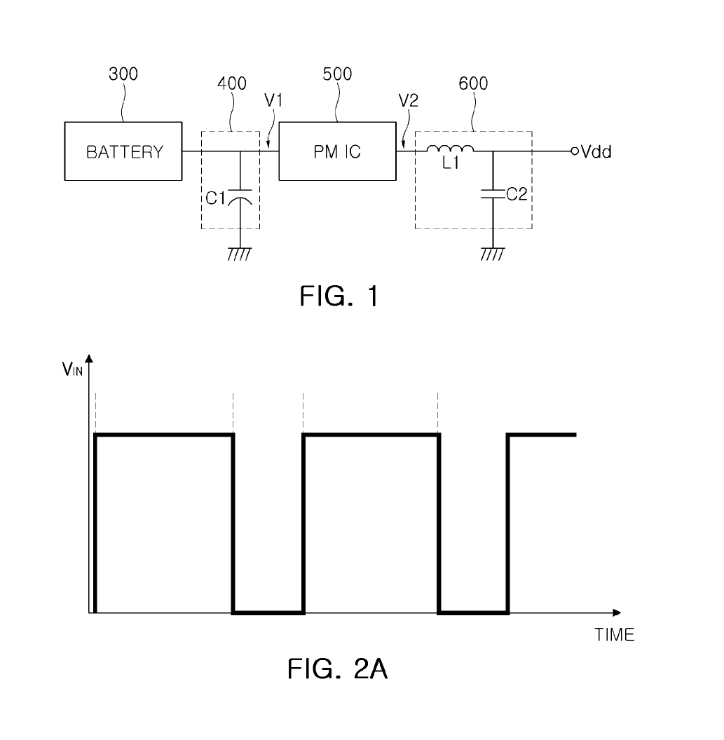

FIG. 1 is a view illustrating a driving power supply system supplying driving power from a battery and a power managing unit to a predetermined terminal requiring driving power.

Referring to FIG. 1, the driving power supply system may include a battery 300, a first power stabilizing unit 400, a power managing unit 500, and a second power stabilizing unit 600.

The battery 300 may supply power to the power managing unit 500. In this case, the power supplied from the battery 300 to the power managing unit 500 is defined as a first power V1.

The first power stabilizing unit 400 may stabilize the first power V1, and the stabilized first power (also denoted by V1) may be supplied to the power managing unit. In detail, the first power stabilizing unit 400 may include a capacitor C1 disposed between a ground and a connecting terminal connecting the battery 300 and the power managing unit 500. The capacitor C1 may reduce ripple included in the first power.

In addition, the capacitor C1 may be charged with electric charge. Further, when the power managing unit 500 momentarily consumes a large amount of current, the capacitor C1 allows the electric charge to be discharged, such that a variation in a voltage of the power managing unit 500 may be suppressed.

The capacitor C1 may be a high capacitance capacitor having a plurality of stacked dielectric layers, the number of which may be 300 or more.

The power managing unit 500 may allow power introduced into an electronic device to be converted so as to correspond to the electronic device, and to be distributed, charged, and controlled. Therefore, the power managing unit 500 may generally include a direct-current (DC) to direct-current (DC) converter.

In addition, the power managing unit 500 may be implemented by a power management integrated circuit (PMIC).

The power managing unit 500 may convert first power (V1) to second power (V2). The second power V2 may be the power required by an active device such as an integrated circuit (IC), or the like, connected to an output terminal of the power managing unit 500 to receive the driving power supplied therefrom.

The second power stabilizing unit 600 may stabilize the second power V2, and may provide the stabilized second power to an output terminal Vdd. The active device such as an IC, or the like, receiving the driving power supplied by the power managing unit 500 may be connected to the output terminal Vdd.

In detail, the second power stabilizing unit 600 may include an inductor L1 connected in series between the power managing unit 500 and the output terminal Vdd. In addition, the second power stabilizing unit 600 may include a capacitor C2 disposed and connected between the ground and a connecting terminal connecting the power managing unit 500 and the output terminal Vdd.

The second power stabilizing unit 600 may reduce ripple included in the second power V2.

In addition, the second power stabilizing unit 600 may stably supply power to the output terminal Vdd.

The inductor L1 may be a power inductor operable at a relatively large amount of current.

The power inductor may indicate an inductor having a lower inductance change and a higher efficiency than those of a general inductor at the time of applying a direct current. For example, the power inductor may include not only functions of the general inductor but also DC bias characteristics (including an inductance change at the time of applying a direct current).

In addition, the capacitor C2 may be a high capacitance capacitor.

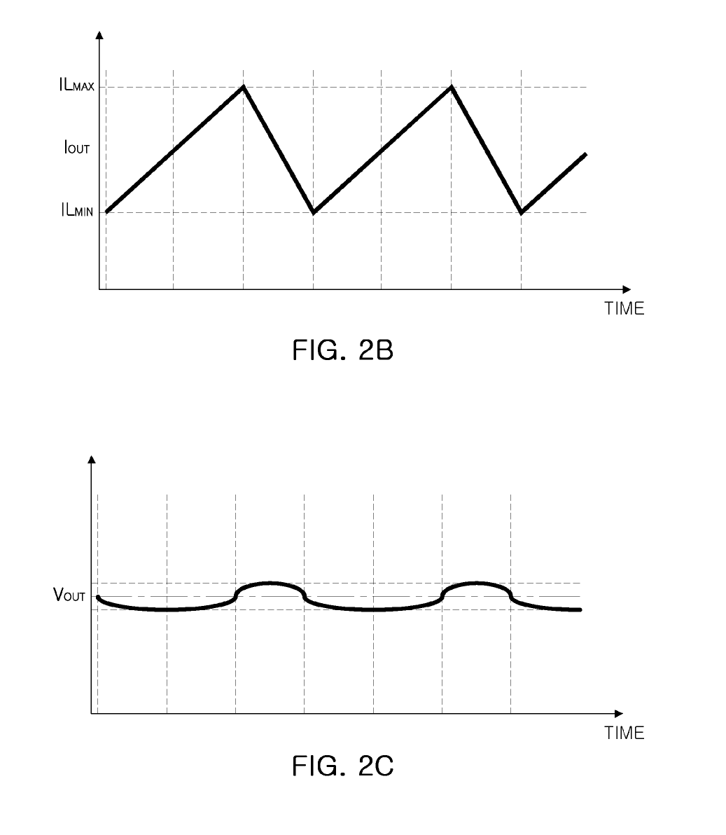

FIG. 2A is a view illustrating a waveform of a power voltage outputted from the power managing unit 500.

FIG. 2B is a view illustrating a current waveform after power outputted from the power managing unit 500 passes through a power inductor L1.

FIG. 2C is a view illustrating a voltage waveform after power having passed through the power inductor L1 passes through a second capacitor C2.

Referring to FIGS. 1 and 2A, the power managing unit 500 may convert the first power V1 inputted through the first power stabilizing unit 400 into the second power V2. FIG. 2A shows a waveform of the second power V2 outputted from the power managing unit 500 as a voltage V_{IN}.

For example, the first power stabilizing unit 400 may decrease ripple of the voltage applied by the battery 300 to supply a DC first power V1 to the power managing unit 500.

The power managing unit 500 may convert the DC first power V1 inputted through the first power stabilizing unit 400 into the second power V2. Here, referring to FIG. 2A, the second power V2 (denoted by V_{IN} in FIG. 2A) may be a pulse width modulation (PWM) voltage (AC voltage). Then, the power managing unit 500 may provide the second power V2 to the second power stabilizing unit 600.

The second power stabilizing unit 600 may include the power inductor L1 having a magnetic main body including coil units and the second capacitor C2 having a ceramic body in which a plurality of dielectric layers and internal electrodes are stacked. The internal electrodes may be disposed to face each other, and a dielectric layer may be interposed therebetween. In addition, the second power stabilizing unit 600 may suppress an alternating current (AC) component of the second power V2 provided from the power managing unit 500, and may decrease ripple.

For example, specifically, the power inductor L1 may suppress the AC component of the second power V2 and the second capacitor C2 may decrease the ripple of the second power V2.

The AC component of the second power V2 which is the PWM voltage may be suppressed after passing through the power inductor L1, thereby forming the current waveform as shown the current waveform in FIG. 2B, in which the value of a current I_{OUT} outputted after passing through the power inductor L1 may range between a minimum current value IL_{MIN} and a maximum current value IL_{MAX}.

Referring to FIG. 2C, the second power V2 after passing through the power inductor L1 may pass through the second capacitor C2 to decrease the ripple. Therefore, the second power V2 after passing through the power inductor L1 may be further converted to an output voltage Vₒᵤₜ after passing through the second capacitor C2, as shown in FIG. 2C. Here, in order to effectively decrease the ripple of the second power V2, the second capacitor C2 may be a high capacitance capacitor having 1 to 100 μF of capacitance.

Therefore, the composite electronic component according to an embodiment of the present disclosure may include the second power stabilizing unit 600 including the power inductor L1 suppressing an alternating current (AC) component of the second power V2 and the second capacitor C2 decreasing ripple of the second power V2, such that a ratio of output power to input power to be inputted to the second power stabilizing unit 600 may be 85% or more.

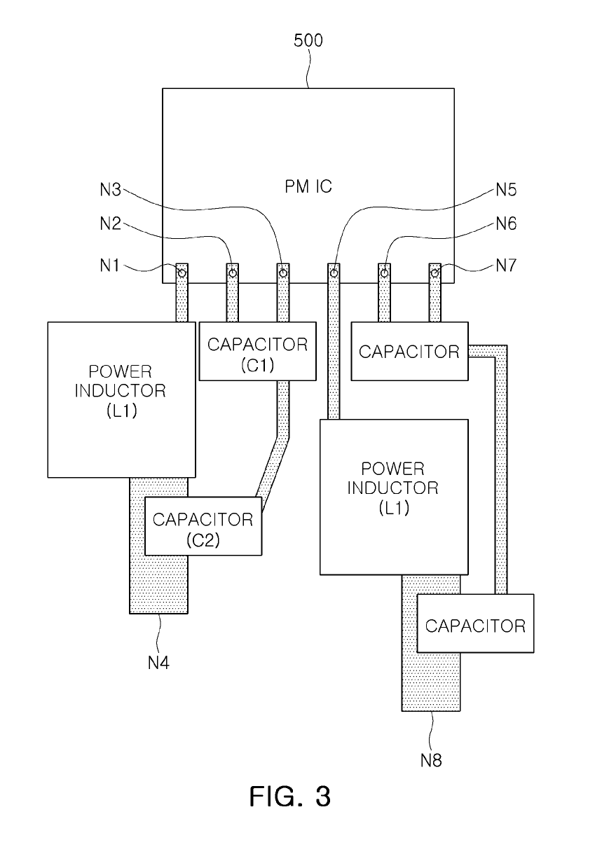

FIG. 3 is a view illustrating a configuration in which the driving power supply system is implemented.

As shown in FIG. 3, the layout of the power managing unit 500, the inductor L1, the first capacitor C1, and the second capacitor C2 are illustrated.

In general, the power managing unit (PMIC) 500 may include several to several tens of DC/DC converters. In addition, in order to implement functions of the DC/DC converter, a power inductor and the high capacitance capacitor may be required for a respective DC/DC converter.

Referring to FIG. 3, the power managing unit 500 may have predetermined terminals N1, N2, and N3. The power managing unit 500 may receive power supplied by the battery through the second terminal N2. In addition, the power managing unit 500 may allow the power supplied from the battery 300 to be converted, and may supply the converted power through the first terminal N1. The third terminal N3 may be a ground terminal.

Here, the first capacitor C1 may be disposed between the ground and the connecting terminal connecting the battery 300 and the power managing unit 500 to perform function of the first power stabilizing unit 400.

In addition, since the inductor L1 and the second capacitor C2 may receive the second power V2 supplied from the first terminal N1, may stabilize the received second power, and may supply the stabilized second power as a driving power to a fourth terminal N4, the inductor L1 and the second capacitor C2 may serve a function of the second power stabilizing unit 600.

Since fifth to eighth terminals N5 to N8 shown in FIG. 3 have the same function as the first to fourth terminals N1 to N4, a detailed description thereof will be omitted.

Important things to be considered when designing the pattern of the driving power supply system are to dispose the power managing unit, the inductor device, and the capacitor device closer to one another. In addition, a wiring of a power line may be designed to be relatively short and thick.

For example, such short and thick wiring may allow for reduction in a component mounting area so as to suppress the generation of noise, by satisfying the above-described requirement.

When output terminals of the power managing unit 500 are provided in a relatively small amount, the inductors and the capacitors may be disposed closer to each other without particular problems. However, in the case of using various outputs of the power managing unit 500, it may be difficult to normally dispose the inductors and the capacitors due to component density. Further, a case in which the inductors and the capacitors should be disposed in a non-optimal state may occur depending on the priority of the power.

For example, since respective sizes of the power inductors and the high capacitance capacitors are relatively large, the power line and a signal line may be inevitably relatively long when the devices are actually disposed.

When the power inductor and the high capacitance capacitor are disposed in the non-optimal state, a distance between devices and the power line may be relatively long, and accordingly, noise may be generated. The noise may have a bad influence on the power supply system.

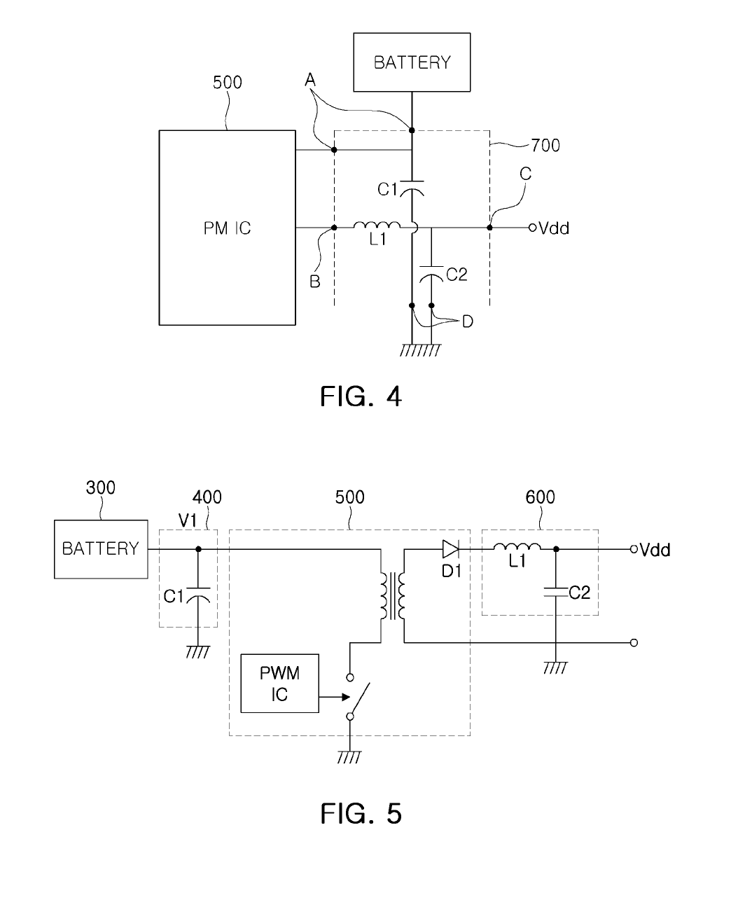

FIG. 4 is a circuit diagram of a composite electronic component according to an embodiment of the present disclosure.

Referring to FIG. 4, a composite electronic device 700 may include a first power stabilizing unit and a second power stabilizing unit.

The first power stabilizing unit may include a first capacitor C1.

The second power stabilizing unit may include a first power inductor L1 and a second capacitor C2.

The composite electronic device 700 may be a device capable of performing the functions of the first power stabilizing unit and the second power stabilizing unit described above.

The composite electronic device 700 may receive the first power supplied by the battery, stabilize the first power, and supply the stabilized first power to the power managing unit 500. Here, referring to FIG. 4, a terminal A receiving the first power supplied from the battery may be the same as a terminal A supplying the first power to the power managing unit 500. For example, a first terminal A (a first input terminal) may receive the first power supplied from the battery and may supply the first power to the power managing unit 500.

In addition, the composite electronic device 700 may receive the second power converted by the power managing unit 500 through a second terminal B (a second input terminal).

Further, the composite electronic device 700 may stabilize the second power to provide the stabilized second power as the driving power to a third terminal C (an output terminal).

Referring to FIG. 4, the first power inductor L1 and the second capacitor C2 may share the third terminal, such that the distance between the first power inductor L1 and the second capacitor C2 may be decreased.

Meanwhile, the composite electronic device 700 may include fourth terminals D (a ground terminal) capable of connecting the first capacitor C1, the second capacitor C2 and the ground. The fourth terminals D may be implemented as a single terminal.

As described above, the composite electronic device 700 may include a large capacitance capacitor provided with an input power terminal of the power managing unit 500, and the power inductor and the large capacitance capacitor provided with an output power terminal of the power managing unit 500 to be implemented as a single component. Therefore, the composite electronic device 700 may have improved device integration.

FIG. 5 is a detailed circuit diagram of a power stabilizing unit including the composite electronic component according to an embodiment of the present disclosure.

Referring to FIG. 5, the power stabilizing unit including a composite electronic component according to the present disclosure may include a battery 300, a first power stabilizing unit 400 stabilizing power supplied from the battery 300, a power managing unit 500 converting the power received from the first power stabilizing unit 400 by a switching operation, and a second power stabilizing unit 600 stabilizing power received from the power managing unit 500.

Here, the power managing unit 500 may include a transformer insulating a first side from a second side, a switching unit positioned on the first side of the transformer and switching the power received from the first power stabilizing unit, a PWM IC controlling the switching operation of the switching unit, and a rectifying unit positioned on the second side of the transformer and rectifying the switched power.

The power managing unit 500 may convert the power received from the first power stabilizing unit 400, for example, the first power V1 into the second power V2 by a switching operation of the switching unit. Here, the PWM IC of the power managing unit 500 may control the switching operation of the switching unit to convert the first power V1 into the second power V2.

Then, the second power V2 may be rectified by the rectifying unit, for example, a diode device D1 to be provided to the second power stabilizing unit 600.

Meanwhile, the second power stabilizing unit 600 may be a composite electronic component including a capacitor C2 and an inductor L1. The capacitor C2 may have a ceramic body in which a plurality of dielectric layers and internal electrodes are stacked. The internal electrodes may be disposed to face each other and a dielectric layer may be interposed therebetween. The inductor L1 may have a magnetic main body including coil units and magnetic bodies. In addition, the inductor L1 may suppress an alternating current (AC) component of the received second power V2 and the capacitor C1 may decrease ripple of the received second power V2.

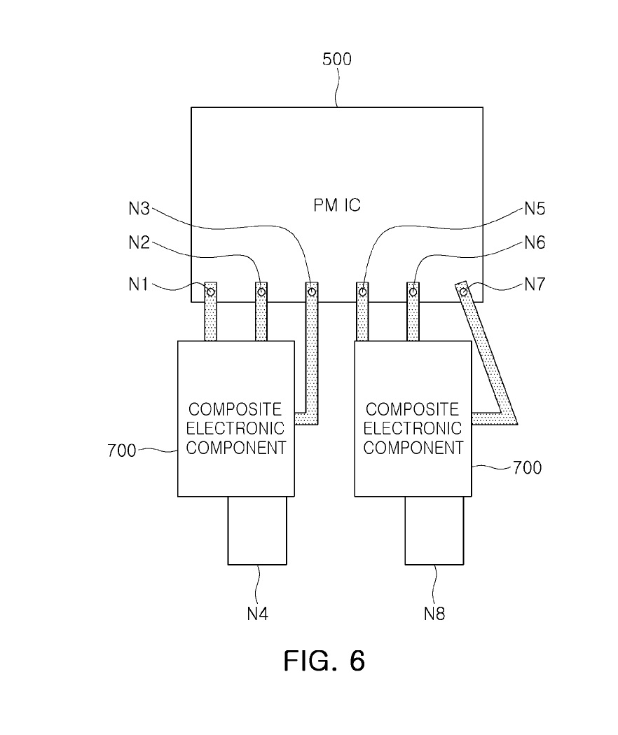

FIG. 6 is a view illustrating a configuration in which the driving power supply system having the composite electronic component applied thereto according to an embodiment of the present disclosure is disposed.

As shown in FIG. 6, the first capacitor C1, the second capacitor C2, and the first power inductor L1 shown in FIG. 3 may be replaced by the composite electronic device according to an embodiment of the present disclosure.

As described above, the composite electronic device may perform functions of the first power stabilizing unit and the second power stabilizing unit.

In addition, the first capacitor C1, the second capacitor C2, the first power inductor L1 may be replaced by the composite electronic component according to an embodiment of the present disclosure, to significantly reduce a length of the wiring. Further, the number of devices may be reduced to be suitable for the layout of the devices.

For example, according to an embodiment of the present disclosure, the power managing unit, the power inductor, the high capacitance capacitor may be disposed relatively closer to one another, and the wiring of the power line may be relatively short and thick, whereby noise may be reduced.

Meanwhile, electronic device manufacturers persevere in their efforts in order to meet consumer's demands and decrease a size of a printed circuit board (PCB) provided in the electronic device. Therefore, an integrated circuit (IC) mounted on the PCB may be required to have increased integration. This requirement may be satisfied by configuring a plurality of devices as a single composite electronic component like the composite electronic component according to an embodiment of the present disclosure.

In addition, according to an embodiment of the present disclosure, three components, for example, the first capacitor, the second capacitor, and the power inductor, may be implemented by a single composite electronic device, to reduce the PCB mounting area. According to an embodiment of the present disclosure, the mounting area may be decreased by about 30 to 50% as compared to an existing pattern in which the components are disposed.

Composite Electronic Component

Directions in a hexahedron will be defined in order to clearly describe the embodiments of the present disclosure. L, W and T shown in the drawings refer to a length direction, a width direction, and a thickness direction, respectively.

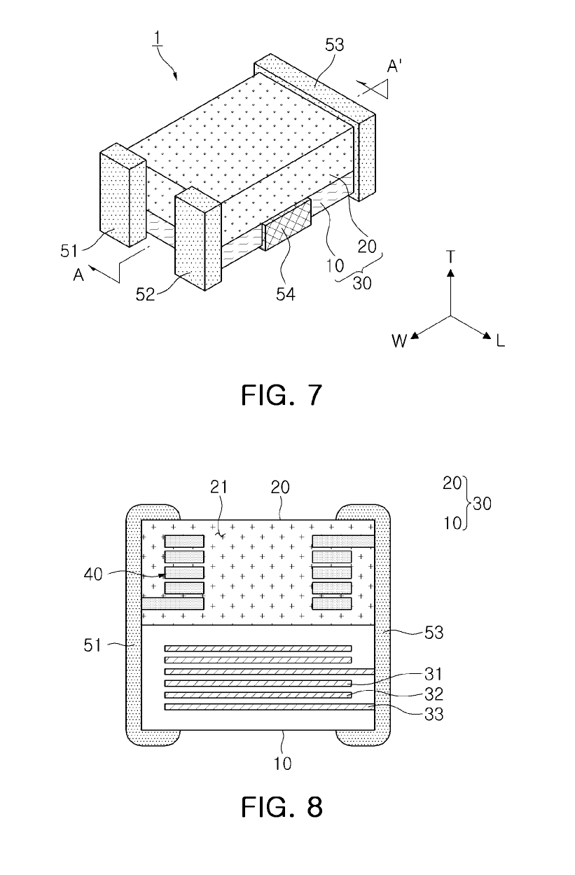

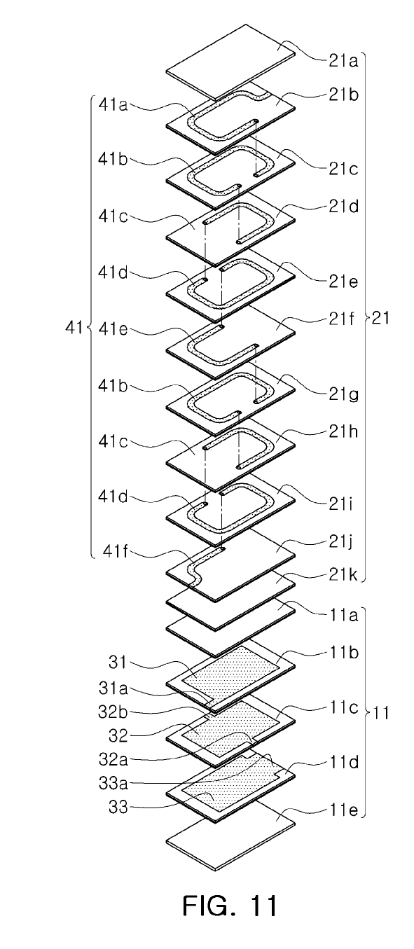

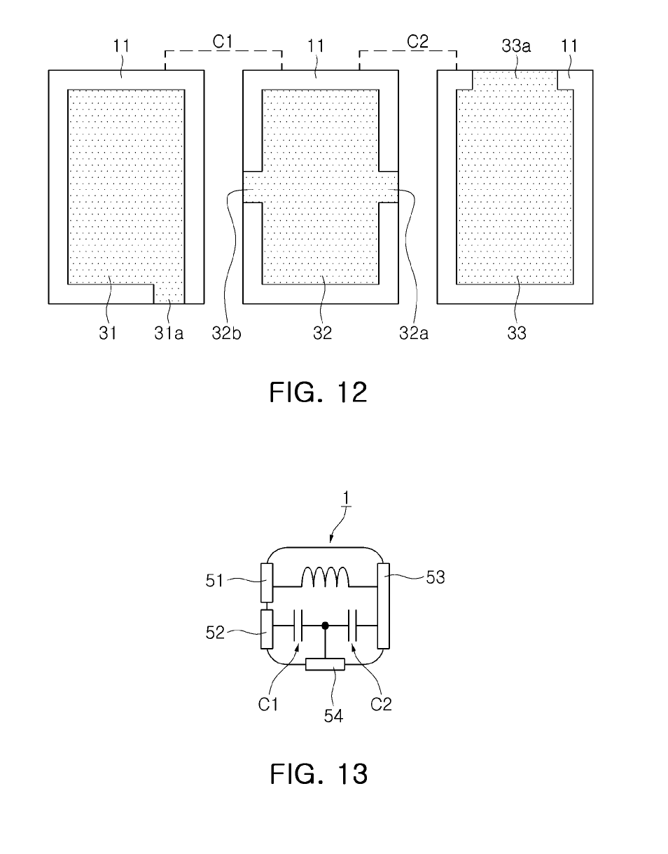

Referring to FIGS. 7 to 12, the composite electronic component 1 according to an embodiment of the present disclosure may include a composite body 30 including a capacitor 10 coupled to an inductor 20. The capacitor 10 may have a ceramic body in which a plurality of dielectric layers 11 (see FIGS. 11 and 12) and internal electrodes 31, 32 and 33 (see FIG. 8) are stacked. The internal electrodes may be disposed to face each other, and dielectric layers 11 may be interposed therebetween. The inductor 20 may have a magnetic main body including coil units 40.

In an embodiment of the present disclosure, the composite body 30 may have first and second main surfaces opposite to each other, and first and second side surfaces and first and second end surfaces connecting the first and second main surfaces to each other.

A shape of the composite body 30 is not particularly limited, but may be a hexahedral shape as shown in FIG. 7.

The composite body 30 having the hexahedral shape may be formed by coupling the capacitor 10 to the inductor 20, and a method of forming the composite body 30 is not particularly limited.

For example, the composite body 30 may be formed by coupling the separately manufactured capacitor 10 and inductor 20 to each other using a conductive adhesion, a resin or the like, or by sequentially stacking the ceramic body configuring the capacitor 10 and the magnetic main body configuring the inductor 20, but the present disclosure is not particularly limited thereto.

Meanwhile, according to an embodiment of the present disclosure, the inductor 20 may be disposed on an upper portion of the capacitor 10, but the location thereof is not limited thereto but may vary.

Hereinafter, the capacitor 10 and the inductor 20 configuring the composite body 30 will be described in detail.

According to an exemplary embodiment of the present disclosure, the magnetic body configuring the inductor 20 may include the coil units 40.

The inductor 20 is not particularly limited, but may be, for example, a multilayer type inductor, a thin film type inductor, or a winding type inductor. In addition to the above-mentioned inductors, a laser helixing type inductor may also be used as the inductor 20.

The multilayer type inductor may be manufactured by thickly printing electrodes on thin ferrite or glass ceramic sheets, stacking several sheets on which coil patterns are printed, and connecting internal conducting wires to each other through via-holes.

The thin film type inductor may be manufactured by forming coil conducting wires on a ceramic substrate by thin film sputtering or plating and filling a ferrite material.

The winding type inductor may be manufactured by winding wires (coil conducting wires) around a core.

The laser helixing type inductor may be manufactured by forming an electrode layer on a ceramic bobbin by sputtering or plating, forming coil shapes by laser helixing, and then processing an external protecting film resin and a terminal.

Referring to FIG. 8, in a composite electronic component according to a first exemplary embodiment of the present disclosure, the inductor 20 may be the multilayer type inductor.

In detail, the magnetic main body may have a form in which a plurality of magnetic layers 21 having conductive patterns 41 formed thereon are stacked. The conductive patterns 41 may configure the coil unit 40.

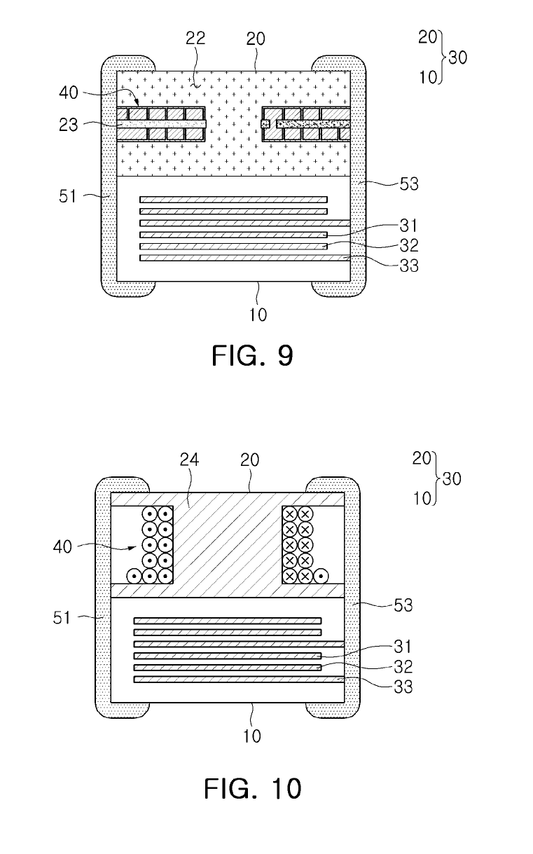

Referring to FIG. 9, in a composite electronic component according to a second exemplary embodiment of the present disclosure, the inductor 20 may be a thin film type inductor.

In detail, the inductor 20 may have a thin film form in which the magnetic body includes an insulating substrate 23 and coils formed on at least one surface of the insulating substrate 23.

The magnetic main body may be formed by filling upper and lower portions of the insulating substrate 23 having the coils formed on at least one surface thereof, with magnetic materials 22.

Referring to FIG. 10, in a composite electronic component according to a third exemplary embodiment of the present disclosure, the inductor 20 may be a winding type inductor.

In detail, the inductor 20 may have a form in which the magnetic main body includes a core 24 and winding coils wound around the core 24.

The magnetic layer 21 and the magnetic body may be formed of a Ni—Cu—Zn based material, a Ni—Cu—Zn—Mg based material, or a Mn—Zn ferrite based material, but are not limited thereto.

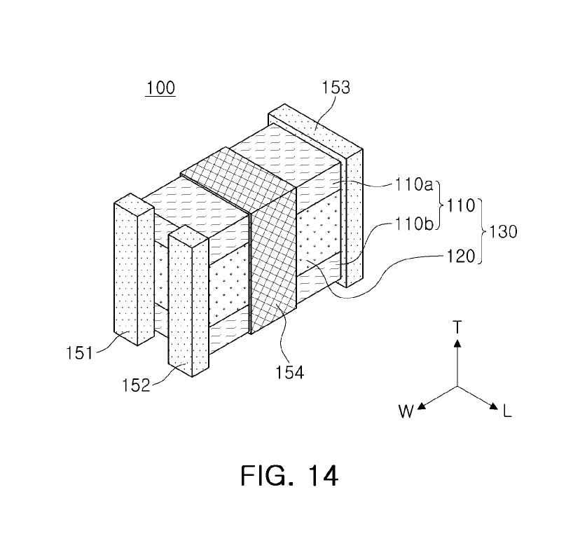

According to an exemplary embodiment of the present disclosure, an inductor 120 (see FIG. 14) may be a power inductor that may be applied to a large amount of current.

The power inductor may be a high efficiency inductor of which an inductance change is smaller than an inductance change of a general inductor when DC current is applied thereto. For example, the power inductor may include DC bias characteristics (characteristics that the inductance thereof changes depending on DC current when the DC current is applied thereto) as well as a function of a general inductor.

For example, the composite electronic component according to an exemplary embodiment of the present disclosure, which is used in a power management integrated circuit (PMIC), may include the power inductor, a high efficiency inductor of which an inductance change is smaller, when the DC current is applied thereto, than an inductance change of a general inductor.

Hereinafter, in the composite electronic components, the case in which the inductor 20 is the multilayer type inductor, which is the first exemplary embodiment of the present disclosure among the first to third exemplary embodiments of the present disclosure, will be described in more detail.

Referring to FIG. 11, the magnetic main body may be manufactured by printing the conductive patterns 41 on the magnetic green sheets 21b to 21j, stacking the plurality of magnetic green sheets 21b to 21j having the conductive patterns 41 formed thereon, additionally stacking the magnetic green sheets 21a to 21k on upper and lower portions thereof, and performing a sintering process.

A Ni—Cu—Zn-based, a Ni—Cu—Zn—Mg-based, and a Mn—Zn-based ferrite-based material may be used for the magnetic body, but the present disclosure is not limited thereto.

Referring to FIG. 11, the magnetic main body may be formed by printing the conductive patterns 41 on the magnetic green sheets 21b to 21j, performing a drying process, and stacking the magnetic green sheets 21a to 21k on upper and lower portions thereof.

In the case of the conductive patterns 41 of the magnetic main body, a plurality of conductive patterns 41a to 41f may be formed on the magnetic green sheets to form coil patterns in a direction in which the magnetic green sheets are stacked.

The conductive patterns 41 may be formed by printing a conductive paste having silver (Ag) as a main component to a predetermined thickness.

The conductive patterns 41 may be electrically connected to a first input terminal 51 and an output terminal 53 (see FIGS. 7-10) formed on both end portions in the length direction.

The conductive patterns 41 may have a lead electrically connected to the first input terminal 51 and the output terminal 53.

One conductive pattern 41a among the conductive patterns 41 may be electrically connected to another conductive pattern 41b, having the magnetic layer 21 interposed therebetween, by a via electrode (not separately shown) formed in the magnetic layer 21b, and the coil pattern may be formed in the stacking direction of the magnetic main body.

In an embodiment of the present disclosure, the coil pattern is not particularly limited, but may be designed to correspond to a capacitance of an inductor.

For example, the second to fifth conductive patterns 41b to 41e may be formed to have a coil form in a stacked form thereof between the first conductive pattern 41a having a lead exposed to the second end surface of the composite body and the sixth conductive pattern 41f having a lead exposed to the first end surface of the composite body, and conductive patterns may be electrically connected to each other by the via electrodes formed in respective magnetic layers as described above.

FIG. 11 shows that the second to fifth conductive patterns 41b to 41e are repeated, respectively; however, the present disclosure is not limited thereto, and the number of conductive patterns to be repeated may be various depending on embodiments.

Meanwhile, the ceramic body configuring the capacitor 10 may be formed by stacking the plurality of dielectric layers 11a to 11e on each other, and the plurality of internal electrodes 31, 32 and 33 (e.g., first, second and third internal electrodes in sequence) may be disposed in the ceramic body so as to be spaced apart from each other, having the dielectric layers (e.g., 11b, 11c, and 11c) interposed therebetween.

The dielectric layers 11 may be formed by sintering a ceramic green sheet containing a ceramic powder, an organic solvent, and an organic binder. As the ceramic powder, a material having a high dielectric constant, a barium titanate (BaTiO₃)-based material, a strontium titanate (SrTiO₃)-based material, or the like, may be used, but the ceramic powder is not limited thereto.

Meanwhile, according to an embodiment of the present disclosure, the internal electrodes may include a first internal electrode 31 having a lead 31a exposed to the first end surface of the composite body 30, a second internal electrode 32 having leads 32a and 32b exposed to one or more of the first and second side surfaces of the composite body, and a third internal electrode 33 having a lead 33a exposed to the second end surface, but the present inventive concept is not limited thereto.

In detail, the ceramic body configuring the capacitor 10 may be formed by stacking the plurality of dielectric layers 11a to 11e.

The first to third internal electrodes 31, 32, and 33 may be formed on portions of the plurality of dielectric layers 11a to 11e, for example, on the dielectric layers 11b to 11d, respectively, to then be stacked on each other.

According to an embodiment of the present disclosure, the first to third internal electrodes 31, 32, and 33 may be formed of a conductive paste containing a conductive metal.

The conductive metal may be nickel (Ni), copper (Cu), palladium (Pd), or an alloy thereof, but is not limited thereto.

The first to third internal electrodes 31, 32, and 33 may be printed using the conductive paste on the ceramic green sheet forming the dielectric layers 11 through a printing method such as a screen printing method or a gravure printing method.

The ceramic green sheets having the internal electrodes printed thereon may be alternately stacked and sintered, to form the ceramic body.

According to an embodiment of the present disclosure, the ceramic body may include a first capacitor unit and a second capacitor unit connected in series.

Referring to FIG. 12, the first capacitor unit C1 may include the first internal electrode 31 having the lead 31a exposed to the first end surface of the composite body 30 and the second internal electrode 32 having the leads 32a and 32b exposed to one or more of the first and second side surfaces.

In addition, the second capacitor unit C2 may include the second internal electrode 32 having the leads 32a and 32b exposed to one or more of the first side surface and the second side surface of the composite body 30 and the third internal electrode 33 having the lead 33a exposed to the second end surface.

FIG. 12 shows pattern shapes of the first to third internal electrodes 31, 32, and 33. However, the pattern shapes of the first to third internal electrodes are not limited thereto, but may be variously changed.

The first capacitor unit C1 and the second capacitor unit C2 may be connected in series in the composite body 30.

The first capacitor unit C1 may control the voltage supplied from the battery power, and the second capacitor C2 may control the voltage supplied from the PMIC.

The composite electronic component 1 according to an embodiment of the present disclosure may include a first input terminal 51 formed on a first end surface of the composite body 30 and connected to the coil unit 40 of the inductor 20 and a second input terminal 52 spaced apart from the first input terminal 51 by a predetermined distance and connected to the internal electrode 31 of the capacitor 10, an output terminal 53 formed on a second end surface of the composite body 30 and connected to the coil unit 40 of the inductor 20 and the internal electrode 31 of the capacitor 10, and a ground terminal 54 formed on one or more of an upper surface, a lower surface, a first side surface, and a second side surface of the composite body 30 and connected to the internal electrode 31 of the capacitor 10.

The first input terminal 51 and the output terminal 53 may be connected to the coil units 40 of the inductor 20, so as to serve as the inductor in the composite electronic component.

In addition, the second input terminal 52 and the output terminal 53 may be connected to the internal electrode of the capacitor 10, and the internal electrode 31 of the capacitor 10 may be connected to the ground terminal 54, so as to serve as the capacitor in the composite electronic component.

The first and second input terminals 51 and 52, the output terminal 53, and the ground terminal 54 may be formed using the conductive paste containing the conductive metal.

The conductive metal may be nickel (Ni), copper (Cu), tin (Sn), or an alloy thereof, but is not limited thereto.

The conductive paste may further contain an insulating material, and the insulating material may be glass, but is not limited thereto.

A method of forming the first and second input terminals 51 and 52, the output terminal 53, and the ground terminal 54 is not particularly limited, and therefore, a method of dipping the ceramic body, a plating method, or the like may be used.

FIG. 13 is an equivalent circuit diagram of the composite electronic component shown in FIG. 7.

Referring to FIG. 13, the inductor 20 and the capacitor 10 may be connected in series by connecting the first input terminal, the second input terminal, the output terminal, and the ground terminal to respective components.

In addition, as described above, the first capacitor unit C1 and the second capacitor unit C2 may be connected in series in the composite body 30.

Since the inductor 20 and the capacitor 10 are coupled to each other in the composite electronic component according to an embodiment of the present disclosure unlike the related art, the distance between the inductor 20 and the capacitor 10 may be designed to be significantly reduced, to thereby reduce the occurrence of noise.

In addition, the inductor 20 and the capacitor 10 may be coupled to each other to significantly reduce the mounting area in the PMIC and thereby have excellence in securing a mounting space.

Further, the cost for mounting may be decreased.

A ratio of output power to input power (output power/input power) inputted to the composite body may be 85% or more.

A frequency of the power inputted to the composite body or outputted therefrom may be 1 to 30 MHz.

The capacitor may have a capacitance of 1 to 100 μF.

The inductor may have an inductance of 0.01 μH to 1.1 μH.

A volume ratio of the magnetic body to the total volume of the composite body (volume of the magnetic body/volume of the composite body) may be 55% to 95%.

The first and second input terminals may be formed on a portion of the first end surface of the composite body.

A current of the power input to the composite body or output therefrom may be 0.1 to 10.0 A.

FIG. 14 is a perspective view schematically illustrating a composite electronic component according to another embodiment of the present disclosure.

Referring to FIG. 14, a composite electronic component 100 according to another embodiment of the present disclosure may include a hexahedral composite body 130, a first input terminal 151, a second input terminal 152, an output terminal 153 and a ground terminal 154. The composite body 130 may be formed by coupling a capacitor 110 to an inductor 120, and the capacitor 110 may be disposed on an upper portion and a lower portion of the inductor 120.

Since features of the composite electronic component 100 according to the embodiment illustrated in FIG. 14, are the same as the foregoing described features of the composite electronic component 1 according to the embodiment illustrated in FIGS. 7-13, except that the capacitors 110 includes a portion 110a disposed on the upper portion and a portion 110b disposed on the lower portion of the inductor 120 and the ground terminal 154 is formed on an upper surface, a lower surface, a first side surface, and a second side surface of the composite body 130 and connected to an internal electrode of the capacitor 110, the overlapped features will be omitted.

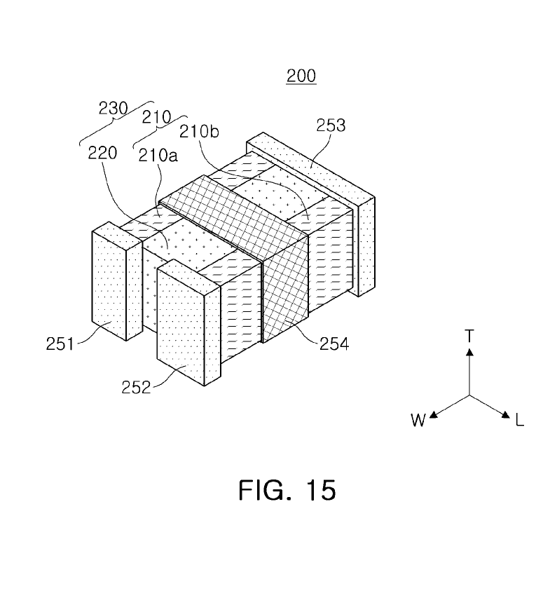

FIG. 15 is a perspective view schematically showing a composite electronic component according to another embodiment of the present disclosure.

Referring to FIG. 15, a composite electronic component 200 according to another embodiment of the present disclosure may include a hexahedral composite body 230, a first input terminal 251, a second input terminal 252, an output terminal 253 and a ground terminal 254. The composite body 230 may be formed by coupling a capacitor 210 to an inductor 220, and the capacitor 210 may be disposed on both sides of the inductor 220.

Since features of the composite electronic component 200 according to the embodiment illustrated in FIG. 15 are the same as the foregoing described features of the composite electronic component 1 according to the embodiment illustrated in FIGS. 7-13 except that the capacitors 210 are disposed on both sides of the inductor 220, i.e., the capacitors 210 includes a portion 210a disposed on one side of the inductor 220 and a portion 210b disposed on another side of the inductor 220, and the ground terminal 254 is formed on an upper surface, a lower surface, a first side surface, and a second side surface of the composite body 230 and connected to an internal electrode of the capacitor 210, the overlapped features will be omitted.

Meanwhile, a composite electronic component used in a power terminal of a portable mobile device, suppressing an alternating current (AC) component of a received power, and decreasing ripple, the composite electronic component may include a power stabilizing unit including a capacitor coupled to an inductor. The capacitor may have a ceramic body in which a plurality of dielectric layers and internal electrodes are stacked. The internal electrodes may be disposed to face each other, and a dielectric layer may be interposed therebetween. The inductor may have a magnetic main body including coil units, an input terminal disposed on one end surface of the power stabilizing unit and receiving power converted by a power managing unit, and an output terminal formed on one end surface of the power stabilizing unit and supplying the power stabilized by the power stabilizing unit. The inductor may suppress the AC component of the received power and the capacitor may decrease ripple of the received power.

The following Table 1 shows decision results of DC-bias characteristic, direct current resistance (Rdc) and ripple decrease characteristics depending on the volume ratio of the magnetic body to the total volume of the composite electronic component (volume of magnetic body/volume of composite electronic component).

A test was performed on the composite electronic component in which the inductor having an inductance of 0.47 μH is coupled to the capacitor having a capacitance of 22 μF, by changing the volume ratio of the magnetic body of the inductor to the total volume of the composite electronic component.

The inductor having an inductance of 0.47 μH and the capacitor having a capacitance of 22 μF may be an inductor having a significantly decreased and a capacitor having a significantly increased used in a mobile device, respectively.

For example, the test was performed under poorest conditions in the composite electronic component, in which even though an inductance is significantly decreased and a capacitance of a capacitor is significantly increased, the most poor conditions may not be in excess.

In the decision of the DC-bias characteristic, a case in which when a predetermined current or more is applied to an inductor, the total inductance is 70% of the designed value or lower than that, was determined as a defect.

For example, in an embodiment of the present disclosure, since the inductor having an inductance of 0.47 μH, a case having an inductance of 0.329 μH which is 70% of the 0.47 pH or less than 0.329 μH was determined as a defect.

When the direct-current resistance (Rdc) is 50 mΩ or more, an efficiency is 85% or less. Therefore, it is difficult to be used in the mobile device due to efficiency deterioration, such that a case in which the direct-current resistance (Rdc) is 50 mΩ or more was determined as a defect.

The ripple decrease characteristic was determined depending on Vp-p (peak to peak) measuring results, and a case in which Vp-p is 10% or more based on the reference voltage was determined as a defect.

TABLE 1

| | | DC-Bias | | |
|---|---|---|---|---|
| | Volume Ratio | Characteristic | | |
| | (%) of Magnetic | (3A Applied) | Rdc | Ripple |
| Sample | Body | (μH) | (mΩ) | Decision |
| *1 | 45 | 0.19 | 55 | ∘ |
| *2 | 50 | 0.25 | 50 | ∘ |
| 3 | 55 | 0.33 | 44 | ∘ |
| 4 | 60 | 0.37 | 42 | ∘ |
| 5 | 65 | 0.43 | 40 | ∘ |
| 6 | 70 | 0.47 | 38 | ∘ |
| 7 | 80 | 0.48 | 35 | ∘ |
| 8 | 90 | 0.49 | 33 | ∘ |
| 9 | 95 | 0.49 | 32 | ∘ |
| *10 | 96 | 0.49 | 32 | x |

*Comparative Example

Referring to Table 1 above, it may be appreciated that in samples 1 and 2, the volume ratio of the magnetic body to the total volume of the composite electronic component (volume of the magnetic body/volume of the composite electronic component) is less than 55%, and the inductance is less than or equal to 0.329 pH which is 70% of 0.47 μH, such that DC-bias characteristic is defective, and the direct-current resistance (Rdc) is 50 mΩ or more, which is defective.

In addition, it may be appreciated that in Sample 10, the volume ratio of the magnetic body to the total volume of the composite electronic component (volume of the magnetic body/volume of the composite electronic component) is more than 95%, and the inductance is less than or equal to 0.329 μH which is 70% of 0.47 μH, such that ripple decrease characteristic is defective.

Meanwhile, it may be appreciated that in samples 3 to 9 in which the volume ratio of the magnetic body to the total volume of the composite electronic component (volume of the magnetic body/volume of the composite electronic component) satisfies the numerical range of the present disclosure, for example, 55% to 95%, all of DC-bias characteristic, Rdc, and ripple decrease characteristic are excellent.

Board Having Composite Electronic Component Mounted Thereon

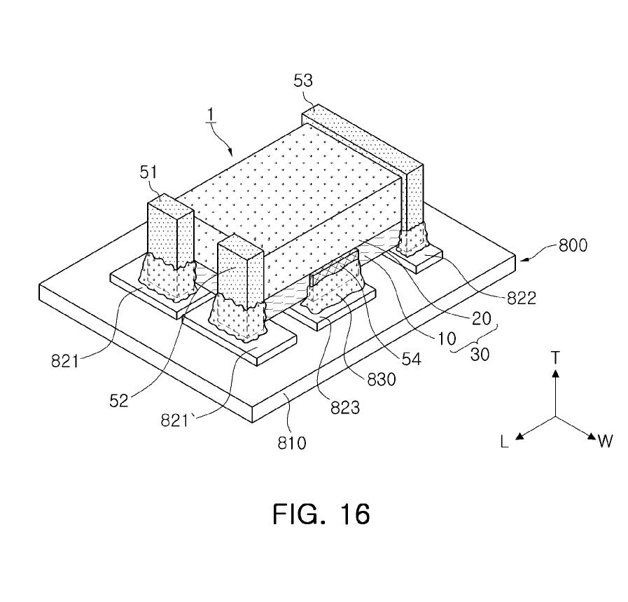

FIG. 16 is a perspective view showing a state in which the composite electronic component shown in FIG. 7 is mounted on a printed circuit board.

Referring to FIG. 16, a board 800 having a composite electronic component 1 mounted thereon according to an embodiment of the present disclosure may include a printed circuit board 810 having the composite electronic component 1 mounted thereon, and four or more electrode pads 821, 821′, 822 and 823 disposed on the printed circuit board 810.

The electrode pad may include first to fourth electrode pads 821, 821′, 822 and 823 connected to a first input terminal 51, a second input terminal 52, an output terminal 53, and a ground terminal 54 of the composite electronic component, respectively.

Here, the first input terminal 51, the second input terminal 52, the output terminal 53, and the ground terminal 54 of the composite electronic component 1 may be electrically connected to the printed circuit board 810 by solders 830 in the state in which they are positioned so as to be in contact with the first to fourth electrode pads 821, 821′, 822, and 823, respectively.

Power Stabilizing Unit

A power stabilizing unit including a composite electronic component according to another embodiment of the present disclosure may include a battery, a first power stabilizing unit stabilizing power supplied from the battery, a power managing unit receiving power converted by the first power stabilizing unit and including a plurality of DC/DC converters and switching devices, and a second power stabilizing unit receiving the power converted by the power managing unit to stabilize the received power. The second power stabilizing unit may be the composite electronic component including a capacitor and an inductor. The capacitor may have a ceramic body in which a plurality of dielectric layers and internal electrodes are stacked. The internal electrodes may be disposed to face each other, and a dielectric layer may be interposed therebetween. The inductor may have a magnetic main body including coil units and magnetic bodies. The inductor may suppress an alternating current (AC) component of the received power and the capacitor may decrease ripple of the received power.

As set forth above, a driving power supply system according to an embodiment of the present disclosure may provide a composite electronic component capable of decreasing a component mounting area.

In addition, a driving power supply system according to an embodiment of the present disclosure may provide a composite electronic component capable of suppressing the occurrence of noise.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A composite electronic component, comprising:
a first power stabilizing unit including a first input terminal receiving first power supplied from a battery, stabilizing the first power, and supplying the stabilized first power to a power managing unit; and
a second power stabilizing unit including a second input terminal receiving second power converted by the power managing unit and an output terminal stabilizing the second power and supplying the stabilized second power as driving power, wherein:
the first and second power stabilizing units include a capacitor and an inductor to stabilize the first power and the second power, the capacitor having a ceramic body in which a plurality of dielectric layers and internal electrodes are stacked, the internal electrodes being disposed to face each other, and a dielectric layer being interposed therebetween,
the inductor has a magnetic main body including coil units and magnetic bodies, and
the inductor is configured to receive power, suppress an alternating current (AC) component of the received power, and the capacitor is configured to decrease ripple of the received power.

2. The composite electronic component of claim 1, wherein a ratio of output power to input power (output power/input power) inputted to the second power stabilizing unit is 85% or more.

3. The composite electronic component of claim 1, wherein a frequency of the power inputted to the second power stabilizing unit or outputted therefrom is 1 to 30 MHz.

4. The composite electronic component of claim 1, wherein the capacitor has a capacitance of 1 to 100 μF.

5. The composite electronic component of claim 1, wherein the inductor has an inductance of 0.01 μH to 1.1 μH.

6. The composite electronic component of claim 1, wherein a volume ratio of the magnetic body to the total volume of the composite electronic component (volume of the magnetic body/volume of the composite electronic component) is 55% to 95%.

7. The composite electronic component of claim 1, wherein the first and second input terminals are disposed on a portion of one end surface of the composite electronic component.

8. The composite electronic component of claim 1, wherein a current of the power inputted to the second power stabilizing unit or outputted therefrom is 1.0 to 10.0 A.

9. The composite electronic component of claim 1, further comprising:
a ground terminal unit connecting the first power stabilizing unit and the second power stabilizing unit to a ground.

10. A composite electronic component, comprising:
a hexahedral composite body including a capacitor coupled to an inductor, wherein the capacitor has a ceramic body in which a plurality of dielectric layers and internal electrodes are stacked, the internal electrodes being disposed to face each other, and a dielectric layer being interposed therebetween, and wherein the inductor has a magnetic main body including coil units;
a first input terminal disposed on a first end surface of the composite body and connected to the coil unit of the inductor;
a second input terminal disposed on the first end surface and spaced apart from the first input terminal and connected to the internal electrodes of the capacitor;
an output terminal disposed on a second end surface of the composite body and connected to the coil unit of the inductor and the internal electrodes of the capacitor; and
a ground terminal disposed on at least any one of an upper surface, a lower surface, a first side surface, and a second side surface of the composite body and connected to the internal electrode of the capacitor,
wherein the inductor and the capacitor are connected in series.

11. The composite electronic component of claim 10, wherein the magnetic main body includes a plurality of stacked magnetic layers having conductive patterns disposed thereon and the conductive patterns configures the coil units.

12. The composite electronic component of claim 10, wherein the inductor has a thin film form in which the magnetic main body includes an insulating substrate and coils disposed on at least one surface of the insulating substrate.

13. The composite electronic component of claim 10, wherein the magnetic main body includes a core and a wiring coil wound on the core.

14. The composite electronic component of claim 10, wherein a ratio of output power to input power (output power/input power) inputted to the composite body is 85% or more.

15. The composite electronic component of claim 10, wherein a frequency of the power inputted to the composite body or outputted therefrom is 1 to 30 MHz.

16. The composite electronic component of claim 10, wherein the capacitor has a capacitance of 1 to 100 μF.

17. The composite electronic component of claim 10, wherein the inductor has an inductance of 0.01 μH to 1.1 μH.

18. The composite electronic component of claim 10, wherein a volume ratio of the magnetic body to the total volume of the composite body (volume of the magnetic body/volume of the composite body) is 55% to 95%.

19. The composite electronic component of claim 10, wherein the first and second input terminals are disposed on a portion of one end surface of the composite body.

20. The composite electronic component of claim 10, wherein a current of the power inputted to the second power stabilizing unit or outputted therefrom is 0.1 to 10.0 A.

21. The composite electronic component of claim 10, wherein the internal electrode includes:
a first internal electrode having a lead exposed to the first end surface of the composite body,
a second internal electrode having leads exposed to one or more of the first and second side surfaces of the composite body, and
a third internal electrode having a lead exposed to the second end surface of the composite body.

22. The composite electronic component of claim 10, wherein the inductor is disposed on an upper portion of the capacitor.

23. The composite electronic component of claim 10, wherein the ceramic body includes first and second capacitor units connected to each other in series.

24. The composite electronic component of claim 10, wherein the capacitor is disposed on an upper portion and a lower portion of the inductor.

25. The composite electronic component of claim 10, wherein the capacitor is disposed on both side surfaces of the inductor.

26. A composite electronic component used in a power terminal of a portable mobile device, suppressing an alternating current (AC) component of received power, and decreasing ripple, the composite electronic component comprising:
a power stabilizing unit including a capacitor coupled to an inductor, wherein the capacitor has a ceramic body in which a plurality of dielectric layers and internal electrodes are stacked, the internal electrodes being disposed to face each other, and a dielectric layer being interposed therebetween, and wherein the inductor has a magnetic main body including coil units;
an input terminal disposed on one end surface of the power stabilizing unit and receiving power converted by a power managing unit; and
an output terminal disposed on one end surface of the power stabilizing unit and supplying the power stabilized by the power stabilizing unit,
wherein the inductor is configured to suppress the AC component of the received power and the capacitor is configured to decrease ripple of the received power.

27. A board having a composite electronic component disposed thereon, the board comprising:
a printed circuit board having electrode pads disposed thereon;
the composite electronic component of claim 1 disposed on the printed circuit board; and
a solder connecting the electrode pad to the composite electronic component.

28. A board having a composite electronic component disposed thereon, the board comprising:
a printed circuit board having electrode pads disposed thereon;
the composite electronic component of claim 10 disposed on the printed circuit board; and
a solder connecting the electrode pad to the composite electronic component.

29. A board having a composite electronic component disposed thereon, the board comprising:
a printed circuit board having electrode pads disposed thereon;
the composite electronic component of claim 26 disposed on the printed circuit board; and
a solder connecting the electrode pad to the composite electronic component.

30. A power stabilizing unit including a composite electronic component, the power stabilizing unit comprising:
a battery;
a first power stabilizing unit stabilizing power supplied from the battery;
a power managing unit converting power received from the first power stabilizing unit by a switching operation; and
a second power stabilizing unit stabilizing power received from the power managing unit, wherein:
the second power stabilizing unit is the composite electronic component including a capacitor and an inductor, the capacitor having a ceramic body in which a plurality of dielectric layers and internal electrodes are stacked, the internal electrodes being disposed to face each other, and a dielectric layer being interposed therebetween,
the inductor has a magnetic main body including coil units and magnetic bodies, and
the inductor is configured suppress an alternating current (AC) component of the received power and the capacitor is configured to decrease ripple of the received power.

31. The power stabilizing unit of claim 30, wherein the power managing unit includes:
a transformer insulating a first side from a second side;
a switching unit positioned on the first side of the transformer and configured to switch the power received from the first stabilizing unit;
a pulse width modulation integrated circuit (PWM IC) configured to control the switching operation of the switching unit; and
a rectifying unit positioned on the second side of the transformer and configured to rectify the converted power.

32. A composite electronic component, comprising:
a hexahedral composite body including a capacitor coupled to an inductor, wherein the capacitor has a ceramic body in which a plurality of dielectric layers and internal electrodes are stacked, the internal electrodes being disposed to face each other, and a dielectric layer being interposed therebetween, and wherein the inductor has a magnetic main body including coil units;
a first input terminal disposed on a first end surface of the composite body and connected to the coil unit of the inductor;
a second input terminal disposed on the first end surface and spaced apart from the first input terminal and connected to the internal electrodes of the capacitor;
an output terminal disposed on a second end surface of the composite body and connected to the coil unit of the inductor and the internal electrodes of the capacitor; and
a ground terminal disposed on an upper surface, a lower surface, a first side surface, and a second side surface of the composite body and connected to the internal electrode of the capacitor.
